(19) United States
(12) Patent Application Publication
(10) Pub. No.: US 2015/0027607 A1
(43) Pub. Date: Jan. 29, 2015

(54) MULTI- CHAMBERED TUBELESS TYRE AND METHOD FOR PRODUCING

(71) Applicant: Smitiparna Satpathy, (US)

(72) Inventors: Smitiparna Satpathy, Ajanta Apartment New Delhi (IN); Kashmanidhi Panda, Ajanta Apartment New Delhi (IN)

(21) Appl. No.: 14/383,179

(22) PCT Filed: Mar. 4, 2013
(86) PCT No.: PCT/IN2013/000119

§ 371 Date: Sep. 5, 2014

(30) Foreign Application Priority Data
Mar. 6, 2012 (IN) 643/DEL/2012
Mar. 6, 2012 (IN) 644/DEL/2012

(51) Int. Cl. B60C 5/24; B60C 17/01; B60C 17/04; B60C 17/00

(52) U.S. Cl. CPC B60C 5/24; B60C 17/00; B60C 17/01; B60C 17/04
USPC 152/333.1

(57) ABSTRACT

A multi-chambered tubeless tyre or tube and manufacturing process for the same for vehicles comprising of a master chamber near wheel rim to keep/contain pressurized air/fluid; at least one chamber sandwiched between said master chamber and inner surface of tyre, said sandwiched chamber(s) has/have independent one way inlet valve for sealant or pressurized fluid/air as the case may be; said sandwiched chamber(s) are formed and joined in green state with said green tube or green tubeless tyre to achieve mechanical properties after vulcanization. Even independent chamber can be sandwiched between said master chamber and inner surface of tyre. This arrangement can be used in all kind of vehicles. It can be used in Self Supporting RFT (Run Flat Tyres), Auxiliary Supported RFT. It can be used for replacement of twin tire by providing extra wide tyre with multiple chambers with/without sealant.

### FIELD OF INVENTION

The field of invention relates to multi-chambered tubeless tyre and tube, independent enclosure for sealant for tyre, and its manufacturing process. The multi-chambered tubeless tyre is related more particularly to tyre with or without sealant for different purposes such as self supporting tyre, extra wide tire etc.

### BACKGROUND

Manufacturing of tuff up tube or multi chambered tube is not possible in the present available manufacturing processes of extrusion and joining Once tube is manufactured and vulcanised any external rubber or any such part can not be fixed permanently. The joining has to be made before vulcanisation as after vulcanisation property of the rubber changes and plasticity is developed. However, in the existing set up for vulcanisation the extruded part is put inside a die and is pressurised by vapour or steam inside it, press it tightly applying temperature & pressure for vulcanisation. In such a situation vulcanisation having multiple hollow parts inside is not possible.

Similarly manufacturing of multi chambered tubeless tyre is not possible in the present available mass manufacturing processes. Once tubeless tyre is manufactured and vulcanised any external rubber or any such part can not be fixed permanently. The joining has to be made before vulcanisation as after vulcanisation property of the rubber changes and plasticity is developed. However, in the existing set up for vulcanisation the green tyre is put inside a die and is pressurised by bellows containing vapour or steam or any hot gaseous substance inside it, press it tightly applying temperature and pressure for vulcanisation. In such a situation vulcanisation having multiple hollow parts inside is not possible.

Moreover in many available prior arts tube or tyre is provided with sealant inside to take care of the punctures. However, these sealants loose their effectiveness because of exposure of pressurised air inside the tyre or tube after sometime. At regular interval the sealant has to be changed. In existing system of tubeless tyre there is no separate chamber for sealant, hence sealant is exposed to air. This not only decreases the life of sealant, but also decreases the life of tyre and causes environmental hazard and cost of ownership is also increased. If the multi-chambered tube, having a specific chamber for the sealant is available than changing of that sealant is not feasible in the prior art.

Sealants in tubeless tyre or tube has many disadvantages such as leakage, hardening of rubber and balancing in static condition; which makes the use of sealant inconvenient and undesirable.

The instant disclosure is based on two priority documents 643/Del/2012 and 644/Del/2012 filed as provisional specification. This disclosure tries to address the problems associated in Prior Art.

### Object & Summary

The main object of the instant disclosure is to obviate the above mentioned drawbacks. A multi-chambered tubeless tyre or tube and manufacturing process for the same for vehicles comprising of a master chamber near wheel rim to keep/contain pressurized air/fluid; at least one chamber sandwiched between said master chamber and inner surface of tyre, said sandwiched chamber(s) has/have independent one way inlet valve for sealant or pressurized fluid/air as the case may be; said sandwiched chamber(s) are formed and joined in green state with said green tube or green tubeless tyre to achieve mechanical properties after vulcanization. Even independent chamber can be sandwiched between said master chamber and inner surface of tyre. This arrangement can be used in in all kind of vehicles. It can be used in Self Supporting RFT (Run Flat Tyres), Auxiliary Supported RFT. The proposed system can be used for replacement of twin tire in commercial vehicles by providing extra wide tyre with multiple chambers with or without sealant.

### BRIEF DESCRIPTION

The invention will now be described with reference to accompanying drawings:

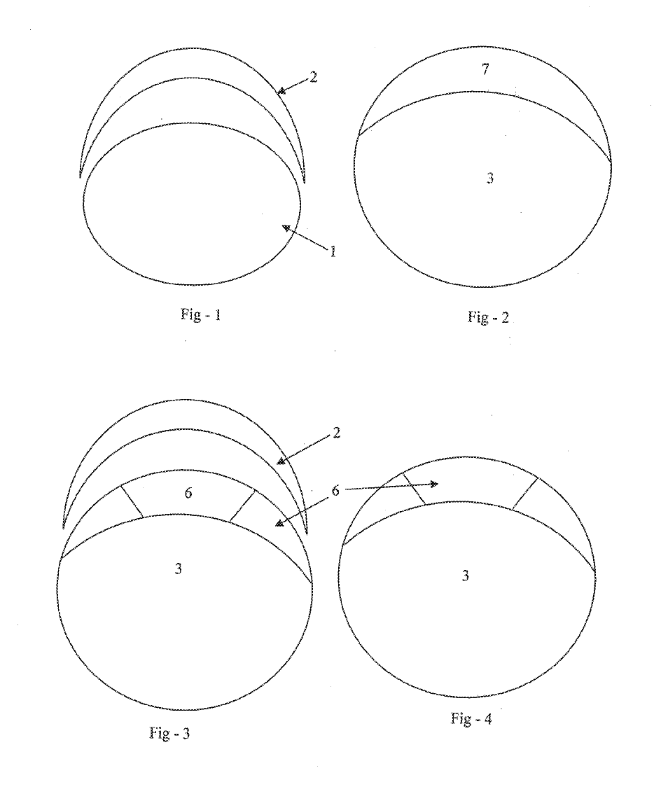

FIG. 1 shows tube with independent enclosure for sealant;

FIG. 2 shows tube with two chambers wherein outer chamber can have sealant;

FIG. 3 shows multi-chambered tube with independent enclosure for sealant;

FIG. 4 shows multi-chambered tube;

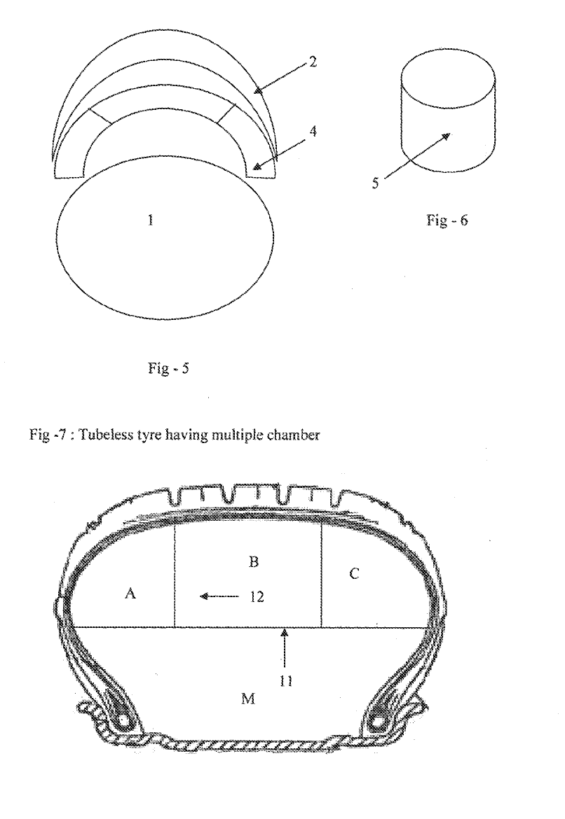

FIG. 5 shows arrangement of separate tube, multi-chambered tube and independent enclosure for sealant;

FIG. 6 shows joiner;

FIG. 7 shows Tubeless tyre having multiple chambers;

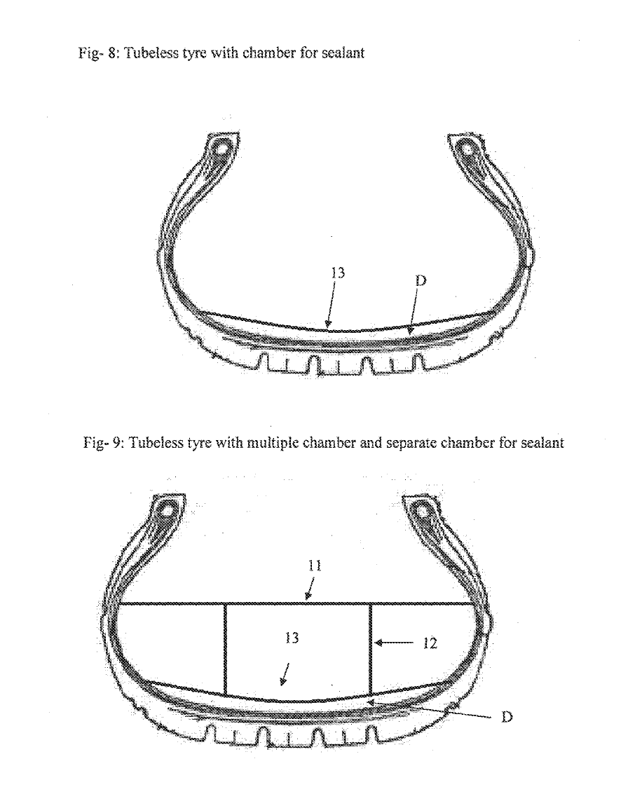

FIG. 8 shows Tubeless tyre with chamber for sealant;

FIG. 9 shows Tubeless tyre with multiple chamber and separate chamber for sealant;

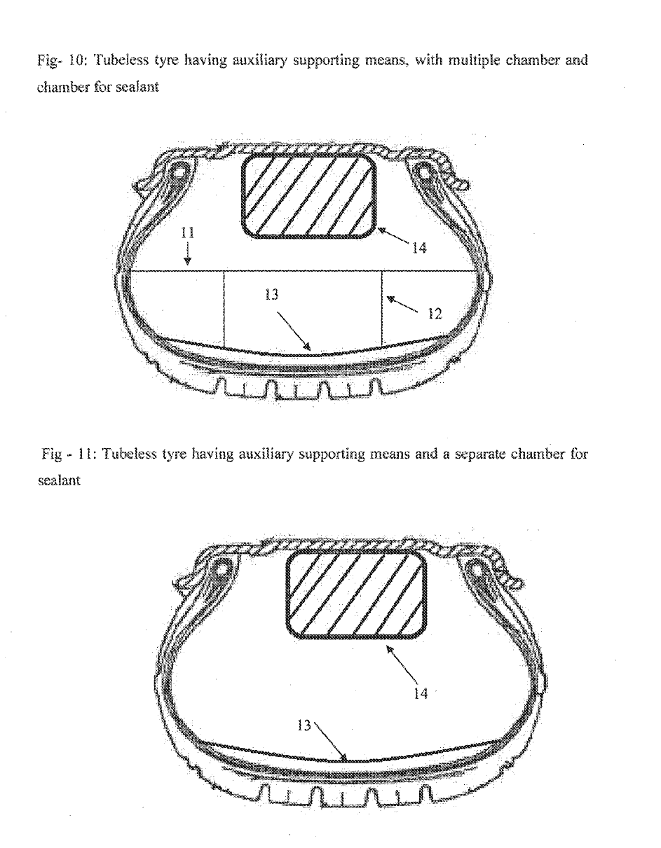

FIG. 10 shows Tubeless tyre having auxiliary supporting means, with multiple chamber and chamber for sealant;

FIG. 11 shows Tubeless tyre having auxiliary supporting means and a separate chamber for sealant;

FIG. 12 shows Self supporting Tubeless tyre having chamber for sealant;

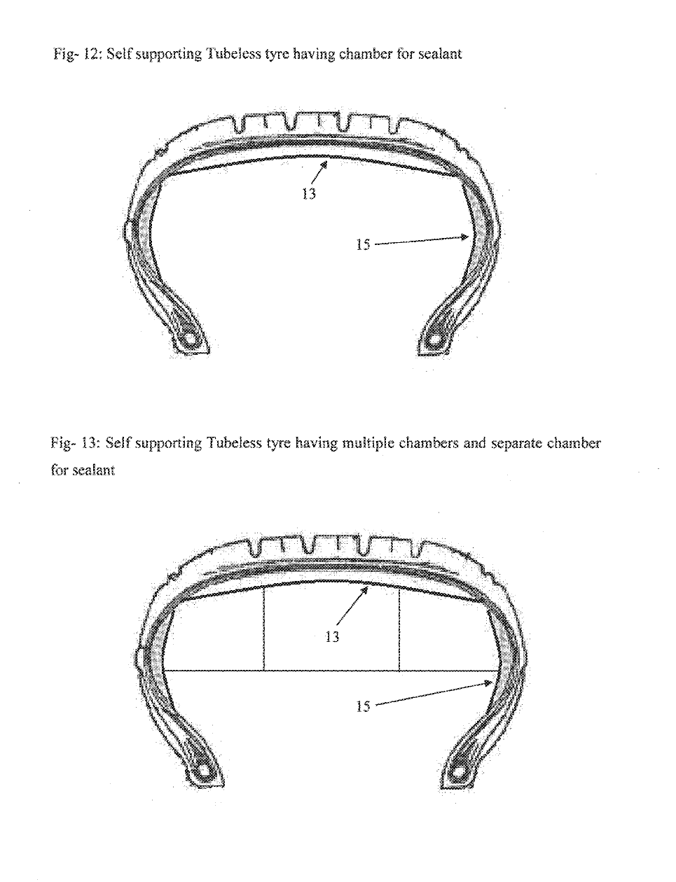

FIG. 13 shows Self supporting Tubeless tyre having multiple chambers and separate chamber for sealant;

FIG. 14 shows Crescent shaped independent enclosure cum inner liner;

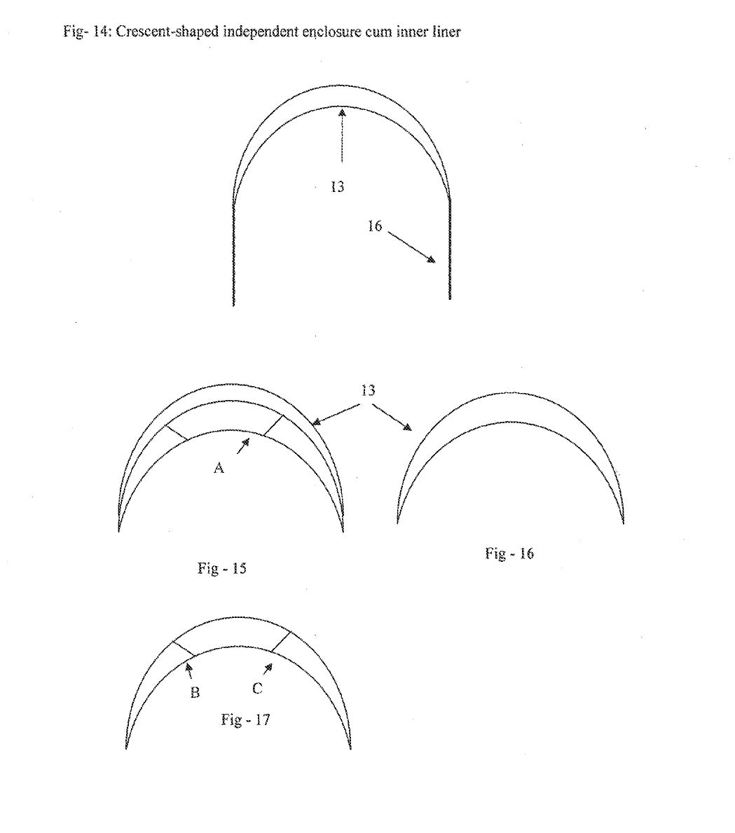

FIG. 15 shows Crescent shaped independent enclosure for sealant and multi-chambered tubular structures;

FIG. 16 shows Crescent shaped independent enclosure for sealant;

FIG. 17 shows independent multi-chambered tubular structures

### DETAILED DESCRIPTION

In the instant disclosure construction of muti-chambered tube, tuff up tube as shown in FIG. 2 are different. The difference in construction helps to meet the objects. The instant disclosure also enumerates different manufacturing process of multi chambered tube, tuff up tube. Multi chambered tube has many parts according to the present disclosure. At least two chambered tube (3, 7) is extruded in one of the embodiment of the present disclosure. At the time of extrusion non-sticky substance as for example powder is provided inside the chambers, so that the walls will not stick to each other. Providing the non-sticky substance such as powder inside the chambers can be done by spraying. The spraying can be a continuous process.

Said two chambered tube can also be manufactured by extrusion of master chamber and joining sheet material from above or below in a continuous process and cutting it according to the requirement of length. Said non-sticky substance will be provided as a separator between surfaces, which are not intended to be joined. Joining can be done by joiners. For better strength at joining surface another strip of sheet material can be joined in such a manner that it will join both the surfaces of the master chamber or main chamber and chamber for sealant. Similar strip can also be used for better strength while joining sheet materials in inner part of tubeless tyre for creating chambers. The joiners shape and size side should be fitting to the contour for perfect match. Such shaped joiners can be made by extrusion or by forming the edges of extruded joiners. The joiners shape can be of crescent shape. These joiners can be used in both tube and tubeless tyre manufacturing for joining both ends of said chambers as and when required.

The extruded part will be cut at a certain length, according to the requirement of the diameter of the tyre. In one embodiment the cut is perpendicular for the convenience of cutting. In another embodiment the cut is angular, rather than perpendicular. The angular cut is such that, the cut surface is exposed to joiner, so that more surface is joined to the joiner. When surface contact is more than the strength of joining is also more. In another embodiment the cut surface is exposed to outer surface, so that the joining looks like continuous and the surfaces will have smoother engagement with other surfaces such as inner surface of the tyre. In one another embodiment the cut portion is having V—shape, so that the joining would be smooth on both sides. V-shaped cut joining helps in providing the requisite extra surface of engagement with the joiner as well as smooth engagement or interaction with the internal surface of the tyre.

Another cylindrical extruded part having outer diameter fitting to the inner diameter of one part of the extruded tube to be used as joiner (5). Similarly the other chamber(s) (6) will also be joined by corresponding joiner(s). The cut end of the joiner is faced towards the outer side, so as to hold and join well with one chamber of multi-chambered tube by increasing the surface area in one of the embodiment. In another embodiment the cut is done in perpendicular manner for ease of cutting.

The joiner will also be joined with one way valve(s) (not shown in figures) in such a way that at the time vulcanisation the pressure of one chamber (3) against the other chamber (7) or (6) will provide required pressure and the heated vapour will give required temperature for joining of said valve(s). The pressure and temperature and the location of valves make the joining permanent and gives adequate strength. So, the portion where joiners are provided are not continuous like the extruded part and valves are provided in this part i.e. in one of the embodiment valve(s) is/are provided on the joiner.

Vulcanisation process can be done in a different manner by providing vapour in required temperature in each chamber by the valves provided on each chamber. A pressure differential may be maintained between the chambers. The pressure differential may help in the process of joining and vulcanisation of the valves.

The outer chamber (7) of the tuff up tube is filled with sealant. Usually it has been observed that the sealant looses it's sealing property after some time and in the available present day system it can not replaced. However in this proposed system the sealant can be replaced, if the customer thinks so. Providing sealant in the tube which is one single cylindrical volume decreases the life of sealant because of interaction of air with the sealant. In the instant disclosure the tuff up tube has two chambers which are made by the process of extrusion, cutting, joining, vulcanization as described in other parts of the disclosure. As the outer chamber and inner chamber are not continuous and one way valve for pressurized fluid is provided in inner chamber and valve for filling sealant is provided in the outer chamber, so sealant can be replaced regularly by the user if he decided to do so. Even providing joiner and separate valves help in maintenance process.

In another embodiment the whole system will have multiple components such as wheel, tube for pressurised air, independent enclosure for sealant (2), joining parts (5), tyre. The independent enclosure for sealant is similar to a tube. It can be made of similar elastomeric material like pneumatic tube. The wall thickness of said independent enclosure can be less than the wall thickness of pneumatic tube. In one embodiment the material of the said independent enclosure is different than pneumatic tube. Said material is relatively less permiable and less reactive to sealant. Also, multi-chambered tube structure (4) can be suitably provided in between according to necessity and convenience.

In one embodiment said independent enclosure for sealant pressed on the side at the time of manufacturing to retain a shape of an arch, so as to properly fit inside the tyre and maintain proper alignment.

Internal surface of said independent enclosure is to be used for joining with said pneumatic tube. Side surfaces of said independent enclosure will be joined with side surface of said pneumatic tube. In another embodiment the joining is done in predetermined place of independent enclosure and pneumatic tube. Joining surfaces can be diagonally opposite to each other, so that there will be uniformity. Providing joiners at diagonally opposite direction can help in balancing and bringing uniformity.

Joining can be done by velcro or any female and male part or by any sticky substance like adhesives, joiners, gum etc. Both parts of velcro be provided on independent enclosure for sealant, so that female or male part will be on independent enclosure for sealant and corresponding other part can be joined on pneumatic tube through sticky substance.

Placement of valve in independent enclosure for sealant should be nearer to the velcro, so that off-set will not be more and engagement or rubbing with pneumatic tube will be minimum. In another embodiment valve should be at outer diameter of tube, so that there will not be any engagement or rubbing with pneumatic tube.

Said valve should be made of elastomeric material and not of any metallic substance. Said material of the valve should be such that it will not harm or harmful impact will be limited for other surfaces.

In one of the embodiment said valve will be made of hard rubber type material having a slit in one end and eleptical surface depression on the other end, such that any pressurised fluid can be forced from side having elliptical surface depression, however can not be forced fed from other side of slit. So, said valve will act as one way valve in normal conditions. However, at the time of maintenance external object with shape of syringe needle can be inserted from eleptical surface depression side and the sealant can be drained if required and new sealant can be filled in the outer chamber. Said sealant can be water soluble or oil soluble. Preferably sealant would be environment friendly having less carbon foot print. Said sealant can be said as green sealant.

In one of the embodiment inside the independent enclosure or inner surface of outer chamber a non reactive coating can be applied, so that sealant and material of said independent enclosure or outer chamber will not react with each other. Because of non reactive coating provided in inner surface, life of sealant and said independent enclosure or outer chamber will increase.

Manufacturing process of independent enclosure involves extrusion, spraying of separating powder, making hole in the enclosure for valve, joining valve in predetermined place, joining by joiner or joining by one end put inside the other end, heating and pressing at the region of joining, vulcanization. Said independent enclosure will undergo more manufacturing processes as described in other parts of the disclosure.

Independent enclosure for sealant help in limiting replacement cost as replacement of one part such as either sealant or independent enclosure or pneumatic tube can be done according to requirement. It can be done in any service station or at road side garage or repair shop or at home also.

There can be different embodiments in tyre tube system such as: tube with integrated independent enclosure for sealant or two chamber tube with one for sealant one with pressurised air, nitrogen; system of pneumatic tube with separate independent enclosure for sealant; system of pneumatic tube with multiple chambers with or without sealant; system of pneumatic tube with multiple chambers and integrated independent enclosure for sealant such that independent enclosure is pressed against puncture prone zone of tyre in its internal surface; system of pneumatic tube with multiple chambers with separate independent enclosure for sealant such that said separate independent enclosure is pressed against puncture prone zone of tyre in its internal surface; system of pneumatic tube with separate multiple chambers with separate independent enclosure for sealant; internal joining with independent enclosure and internal surface of tyre along with pneumatic tube.

There can be different types of manufacturing processes and different combinations of the processes for manufacturing different embodiments. For example two parts can be independently manufactured and they can work in synergy, such that one part will be pneumatic tube other part can be independent enclosure having sealant or multi chambered pneumatic tube having different air inlet valve for each chamber. Another example of manufacturing process can be three parts independently manufactured and working in synergy where one part will be pneumatic tube other part can be independent enclosure having sealant and third part can be multi chambered pneumatic tube having different air inlet valve for each chamber. In yet another example one system having different parts can be extruded at a time and manufactured as described in the disclosure.

In the existing system in many commercial vehicles such as bus, truck etc. usually in rear two wheels and correspondingly two tyres and two tubes are used adjacent to each other. Multiple system decreases the risk and increases the load carrying capability and reliability. At the same time cost and material used also increases; which further increases carbon foot print and make the overall system less environment friendly, more expensive and decreases the load carrying volume etc. To replace such system an arrangement for low aspect ratio tyre with high load taking capability can be used as replacement of two tyres with combination above tube systems according to need. In the proposed embodiment two tyres tubes and wheels will be replaced by one single tyre with extra width, multi-chambered tube with or without sealant and one wheel, so that the material used will be less and reliability is not compromised, rather improved.

In the instant disclosure construction of muti-chambered tubeless tyre with or without chamber for sealant are different. The difference in construction helps to meet the objects. The instant disclosure also enumerates different manufacturing process of multi chambered tubeless tyre with or without chamber for sealant.

Incase of tubeless tyre the material similar to that of inner liner or sheet material in the inner surface of tubeless tyre or material of tube such as butyl rubber can be used to manufacture chamber(s) to be joined in the inner part of tubeless tyre. Said chamber(s) is/are manufactured by process of extrusion. In another embodiment inner chamber is manufactured by way of joining sheets of material in specified locations at the time green tyre is made.

Multi chambered tubeless tyre has many parts according to the present disclosure. At least one chamber is provided adjacent to inside surface of tubeless tyre in one of the embodiment of the present disclosure. At the time of extrusion or making of such chamber(s) non-sticky substance as for example powder is provided inside the chamber(s), so that the walls will not stick to each other. Providing the non-sticky substance such as powder inside the chamber(s) can be done by spraying. FIG. 7 shows a construction of multi-chambered tubeless tyre, said tubeless tyre can be normal tubeless tyre or a self supporting run-flat tyre or an auxiliary supported run flat tyre. The internal chambers can be manufactured by joining the rolled sheets or extruded multi-chambered tubular structure in internal part of the green tyre and then vulcanised. Said sheet can be of shape of flat surface (11) having multiple walls (12) equidistant from each other. Another sheet (13) can also be provided for creating a chamber for sealant (D). Said tubular structure can be different shapes as shown in FIG. 15, FIG. 16 and FIG. 17. In one of the embodiment where the chamber (D) is sandwiched between chambers (A), (B), (C); which are connected to master chamber (M), the sealant can be put inside chamber (D) by a separate one way valve, which may be provided by a separate conduit whose opening would be available for operation.

In case of tubeless tyre the area where multi-chambered inner sack(s) is/are to be joined, is/are not coated with non-sticky material like powder. This can be achieved by different methods, such as spraying or applying non-sticky material like powder in selective area only, or providing a detachable flexible sheet in this part, such that it can be pilled up afterwards and the multi-chambered part can be joined.

The extruded part/sheet material will be cut at a certain length, according to the requirement of the diameter of the tyre. In one embodiment the cut is perpendicular for the convenience of cutting. In another embodiment the cut is angular, rather than perpendicular. The angular cut is such that, the cut surface is exposed to joiner, so that more surface area is joined to the joiner. When surface contact is more than the strength of joining is also more. In another embodiment the cut surface is exposed to outer surface, so that the joining looks like continuous and the surfaces will have smoother engagement with other surfaces such as inner surface of the tyre. In one another embodiment the cut portion is having V—shape, so that the joining would be smooth on both sides. V-shaped cut joining helps in providing the requisite extra surface of engagement with the joiner as well as smooth engagement or interaction with the internal surface of the tyre.

Another cylindrical extruded part having outer diameter fitting to the inner diameter of one part of the extruded sack/chamber to be used as joiner. Similarly the other chamber(s) will also be joined by corresponding joiner(s). The cut end of the joiner is faced towards the outer side, so as to hold and join well with one chamber of multi-chambered tube by increasing the surface area in one of the embodiment. In another embodiment the cut is done in perpendicular manner for ease of cutting. Joiner and extruded part will be joined with use of temperature and pressure. Similarly requisite shape of chamber(s) can be achieved by joining sheet material according to the shape and size with use of temperature and pressure.

The joiner will also be joined with one way valve(s) in such a way that at the time vulcanisation the pressure of one chamber against the bellow will provide required pressure and the heated vapour will give required temperature for joining of said valve(s). The pressure and temperature and the location of valves make the joining permanent and gives adequate strength. Joiners are provided in such a way that the portion where joiners are provided gives similar effect of continuous joining like the extruded part. In one of the embodiment valve(s) is/are provided on the joiner. In another embodiment valve(s) are provided in the major part i.e. extruded part or sheet material. Said joiners will be also of same or similar material of sack(s) or chamber(s).

In case of tubeless tyre vulcanisation process is different. The chambers nearer to the outer surface will be provided with heated vapour by the valves of each chamber and for the larger chamber or main chamber nearer to the inner circle of the tyre bellows can be used for vulcanisation. Hence, unlike the prior art vulcanisation can be done directly by heated bellows and heated vapour for different part of the tyre. Tubeless tyre with only one chamber/enclosure for sealant can be vulcanised with bellow only by providing non-sticky powder kind of separator on the surface area where sealant will be inserted. In another manufacturing process of tubelss tyre with one chamber/enclosure for sealant can be vulcanised by heated vapour and bellow as described in previous lines. Instead of vapour, heated nitrogen or such non reactive fluid can also be used for vulcanisation, which will decrease the possibility of reaction of heating medium with heated substance.

Vulcanisation process can be done in a different manner by providing vapour/heated nitrogen/heated non reactive gaseous substance in required temperature in each chamber by the valves provided on each chamber. A pressure differential can be maintained between the chambers. The pressure differential can help in the process of joining and vulcanisation of the valves.

In multi chambered tubeless tyre the chamber is provided adjacent to internal surface of tubeless tyre near the puncture prone zone and it is filled with sealant. Usually it has been observed that the sealant looses it's sealing property after some time and in the available present day system it can not be provided in an enclosure so that interaction with air or any such gaseous substance can be avoided. Moreover in this proposed system the sealant can be replaced, if the customer thinks so. Providing sealant in the tubeless tyre which is one single cylindrical volume decreases the life of sealant because of interaction of air with the sealant. In the instant disclosure the tubeless tyre has exclusive one chamber for keeping sealant and provided with a valve for filling sealant, so sealant can be replaced regularly by the user if he decided to do so. Even providing separate valve(s) help in maintenance process.

In another embodiment the whole system will have multiple components such as wheel, tubeless tyre having pressurised air or nitrogen, independent enclosure for sealant, joining parts, valve for pressurised air, valve for sealant. The independent enclosure for sealant is similar to a tube. It can be made of similar elastomeric material like pneumatic tube or inner liner of tubeless tyre. The wall thickness of said independent enclosure can be less than usual wall thickness of pneumatic tube. In one embodiment the material of the said independent enclosure is different than pneumatic tube. Said material is relatively less permeable and less reactive to sealant.

In one embodiment said independent enclosure for sealant pressed on the side at the time of manufacturing to retain a shape of an arch, so as to properly fit inside the tubeless tyre and maintain proper alignment.

While joining sheet or independent enclosure or multiple chamber with green tyre in the inside surface adhesive; or heat and pressure; or both adhesive, heat & pressure can be used for joining at an initial stage to give adequate alignment and strength.

In another embodiment the inner liner can be extruded to form a shape of crescent at the center and sheets at both sides, so as to join the same inside green tyre before vulcanisation. In inner surface of double layered sheets formed in crescent, separator such as powder will be provided at the time of extrusion. Single piece extruded crescent shaped independent enclosure cum inner liner will have advantage of minimising defects, as similar shape achieved by joining two parts will have defect at and nearby region of joining

Outer surface of said independent enclosure can be used for joining with said tubeless tyre from inside. Side surfaces of said independent enclosure will be joined with side surface of said pneumatic tubeless tyre. In another embodiment the joining is done in predetermined place of independent enclosure and pneumatic tubeless tyre. Joining surfaces can be diagonally opposite to each other, so that there will be uniformity. Providing joiners at diagonally opposite direction can help in balancing and bringing uniformity. Once this independent enclosure is joined to internal surface of tubeless tyre, pressurised air/nitrogen helps in keeping the arrangement in stable condition.

Joining can be done by velcro or any female and male part or by any sticky substance like adhesives, joiners, gum etc. Both parts of velcro be provided on independent enclosure for sealant, so that female or male part will be on independent enclosure for sealant and corresponding other part can be joined on inner surface of pneumatic tubeless tyre through sticky substance. Such a system can be adoptable in already manufactured tubeless tyre and in after sales market as well. Valve for replacement of sealant will be provided towards inner side of the independent enclosure, such that at the time of maintenance sealant can be readily changed.

In one embodiment said valve may be made of elastomeric material and not of any metallic substance. In another embodiment said valve may be made of any metallic substance and for ease of joining rubber like material can be provided surrounding it.

In one of the embodiment said valve will be made of hard rubber type material having a slit in one end and elliptical surface depression on the other end, such that any pressurised fluid can be forced from side having elliptical surface depression, however can not be forced fed from other side of slit. So, said valve will act as one way valve in normal conditions. However, at the time of maintenance external object with shape of syringe needle can be inserted from elliptical surface depression side and the sealant can be drained if required and new sealant can be filled in the outer chamber. Said sealant can be water soluble or oil soluble. Preferably sealant would be environment friendly having less carbon foot print. Said sealant can be said as green sealant.

In one of the embodiment inside the independent enclosure or inner surface of outer chamber a non reactive coating can be applied, so that sealant and material of said independent enclosure or outer chamber will not react with each other. Because of non reactive coating provided in inner surface, life of sealant and said independent enclosure or outer chamber will increase.

Manufacturing process of independent enclosure involves extrusion, spraying of separating powder, making hole in the enclosure for valve, joining valve in predetermined place, joining by joiner or joining by one end put inside the other end, heating and pressing at the region of joining, vulcanisation. Said independent enclosure will undergo more manufacturing processes as described in other parts of the disclosure.

Independent enclosure for sealant help in limiting replacement cost as replacement of one part such as either sealant or independent enclosure or pneumatic tubeless tyre can be done according to requirement. It can be done in any service station or at road side garage or repair shop or at home also.

There can be different embodiments in tubeless tyre system such as: tubeless tyre with integrated independent enclosure for sealant; tubeless tyre with integrated enclosure for sealant manufactured from sheet material; tubeless tyre with integrated enclosure for sealant where said enclosure is manufactured by way of extrusion and joined inside the inner wall of tubeless tyre; system of pneumatic tubeless tyre with multiple chambers; system of pneumatic tubeless tyre with multiple chambers and independent enclosure for sealant where said enclosure can be manufactured from sheet material or by way of extrusion and said independent enclosure can also be integrated or separate from said tubeless tyre; self supporting tubeless tyre with chambers, with sealant, with chambers and sealant; tubeless tyre having a supporting unit with chambers, with sealant, with chambers and sealant. In different embodiments of tubeless tyre, valve will be provided towards inner side in the sealant chamber, so that the sealant can be filled and replaced at the time of need. In multiple chambers having pressurised fluid as for example air, nitrogen; separate one way valve is provided for each chamber to put these pressurised fluid. For passage of this pressurised fluid to each chamber, conduit or hose is provided.

In today's system self supporting tyres are heavier than tubeless tyre. Moreover as the thickness of side wall is increased and different material is provided which stiffens the side wall tyre; the weight increases. It has also coherent problem of shorter life than general tubeless tyre. Due to increased thickness of side wall, the cushioning effect decreases and vibrations are transferred to suspension system of the vehicle and comfort as well as life of the vehicle is compromised. In the proposed embodiment of self supporting tyre with chamber for sealant or multiple chambers and sealant or multi chamber; the wall thickness can be decreased as well as the stiffness. The proposed thickness and/or stiffness will remain in between the parameters of existing tubeless tyre and self supporting run flat tyre. So, the vibration transmitted by the side wall will be less than self supporting run flat tyre, which will improve the comfort level, weight, cost as well as life of the tyre, suspension system and other parts of the vehicle which are directly affected by vibration transmitted by tyre. Incase of simple puncture the vehicle will not in run flat mode rather will run at low pressure mode or will be automatically repaired by sealant; so the life of tyres will increase. Only incase of urgency, the system will run in run flat mode.

Similarly in auxiliary supported run flat tyre providing chamber for sealant or multiple chambers; or multiple chambers with separate chamber for sealant will help in increasing the life of the system as incase of simple puncture the vehicle will not in run flat mode rather will run at low pressure mode or will be automatically repaired by sealant. Only incase of urgency, the system will run in run flat mode.

There can be different types of manufacturing processes and different combinations of the processes for manufacturing different embodiments. For example two parts can be independently manufactured and they can work in synergy, such that one part will be pneumatic tubeless tyre, other part can be independent enclosure having sealant. In yet another example one system having different parts can be made at a time and vulcanised at a time.

In the existing system in many commercial vehicles such as bus, truck etc. usually in rear two wheels and correspondingly two tyres and two tubes are used adjacent to each other. In few cases one big tubeless tyre with low aspect ratio is also used, however in such system reliability is less and possibility of accident increases at the time of puncture. Multiple systems decrease the risk and increase the load carrying capability and reliability. At the same time cost and material used also increases; which further increases carbon foot print and make the overall system less environment friendly, more expensive and decreases the load carrying volume etc. To replace such system an arrangement for low aspect ratio tyre with high load taking capability can be used as replacement of two tyres with combination of above embodiments according to need such as with chambers, with sealant, with chambers and sealant etc.

Crescent shaped independent enclosure cum inner liner as shown in FIG. 14 shows the chamber containing sealant (D) by sheet material (13) and inner liner (16). And FIG. 15 shows Crescent shaped independent enclosure (D) for sealant and multi-chambered tubular structures (A), (B), (C) and FIG. 16 shows Crescent shaped independent enclosure (D) for sealant and FIG. 17 shows independent multi-chambered tubular structures (A), (B), (C). These units can be used as a separate independent unit and can be retrofitted or it can also be joined in green state with green tubeless tyre for vulcanisation.

A multi-chambered tubeless tyre or tube and manufacturing process for the same for vehicles comprising of a master chamber near wheel rim to keep/contain pressurized air/fluid; at least one chamber sandwiched between said master chamber and inner surface of tire, said sandwiched chamber(s) has/have independent one way inlet valve for sealant or pressurized fluid/air as the case may be; said sandwiched chamber(s) are formed and joined in green state with said green tube or green tubeless tire to achieve mechanical properties after vulcanization.

A multi-chambered tubeless tyre or tube and manufacturing process for the same for vehicles comprising of a master chamber near wheel rim to keep/contain pressurized air/fluid; at least one independent chamber sandwiched between said master chamber and inner surface of tyre, said sandwiched chamber(s) has/have independent one way inlet valve for sealant or pressurized fluid/air as the case may be; said tube or tubeless tyre or independent chamber being independently vulcanized are removably joined in such a way that said independent chamber(s) is/are sandwiched between tyre and master chamber.

Said multiple chambers in tube is manufactured by way of extrusion by providing multiple mandrels, separator is being provided between surfaces which are not intended to be joined, said multi-chambered tube is cut according to requirement of length, said master chamber is joined with a one way valve for air/fluid inlet, both ends of each individual chambers are joined by joiner in green state, said multi-chambered tube is being vulcanized as a single unit.

Said multiple chambers in tube is manufactured by way of extrusion of master chamber, joining of sheet material below or above said master chamber, separator is being provided between surfaces which are not intended to be joined, said multi-chambered tube is cut according to requirement of length, said master chamber is joined with a one way valve for air/fluid inlet, both ends of each individual chambers are joined by joiner in green state, said multi-chambered tubeless tyre is being vulcanized as a single unit. Said multiple chambers in tubeless tyre is manufactured by joining surfaces of sheet(s) to inner surface of tubeless tyre in green state; wherein said sheet can be of shape of flat surface having at least one wall equidistant from both ends joining side walls of tubeless tyre.

Said multiple chambers is manufactured by joining green multiple chamber unit with green tubeless tyre or tube as the case may be, are being vulcanized in such manner that chambers nearer to the outer surface will be provided with heated vapour or non-reactive fluid by the valves of each chamber; said main chamber and inner circle of the tyre or tube are vulcanised by bellows or tubeless tyre or tube with only one additional chamber for sealant can be vulcanised with bellows or by heated vapour or both. Said multiple chambers unit are made up of material having similar property of inner liner or butyl rubber by way of extrusion by providing multiple mandrels to make multiple chambers or extrusion of master chamber and joining of sheet material below or above said master chamber or extrusion/rolling of crescent shaped structure with elongated surfaces to act as inner liner; separator is being provided between surfaces which are not intended to be joined, said multiple chambered unit is cut according to requirement of length, said chambers are joined with a one way valve for air/fluid/sealant inlet, both ends of each individual chambers are being joined by joiner in a green state.

Said joiners, multiple chambers units or independent joiners are formed by way of rolling or extrusion in similar shaped die in such a shape and size so that they fit into requirement of edges. The chambers cut of extruded part/sheet material is being cut perpendicular or V-shaped or angular such that cut surface is exposed to joiner or to outer surface, wherein two ends are joined by joiner by use of pressure and temperature or joining solution, said joiner is cylindrical shaped or crescent shaped with perpendicular or V-shaped or angular cut at its both ends and provided with one way valve on its surface. Additional strip of material with similar property of said inner liner or said butyl rubber in such a way that it increases the strength of joining Non reactive paint or sticky solution or layer is provided in inner surface of chamber wherein sealant is provided to increase life of sealant and tyre or tube. Said sandwiched chamber is one chamber to have sealant, or multiple chamber with sealant or without sealant. Said tyre is a self-supporting run flat tyre such that side wall (15) thickness and/or strength and/or stiffness is in-between normal tubeless tire and self-supporting tubeless tyre. Said tyre is auxiliary supported (14) run flat tire. Said tyre is extra wide tire with multiple chambers for commercial vehicles as a replacement of twin tire.

Although the invention has been described with reference to specific embodiments, this description is not meant to be construed in a limited sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

1. A multi-chambered tubeless tyre system for vehicles comprising of a master chamber near wheel rim to keep/contain pressurized air/fluid; at least one chamber sandwiched between said master chamber and inner surface of tire, said sandwiched chamber(s) has/have independent one way inlet valve for sealant or pressurized fluid/air as the case may be; said sandwiched chamber(s) are formed and joined in green state with said green tube or green tubeless tire to achieve mechanical properties after vulcanization.

2. A multi-chambered tubeless tyre system for vehicles comprising of a master chamber near wheel rim to keep/contain pressurized air/fluid; at least one independent chamber sandwiched between said master chamber and inner surface of tyre, said sandwiched chamber(s) has/have independent one way inlet valve for sealant or pressurized fluid/air as the case may be; said tube or tubeless tyre or independent chamber being independently vulcanized are removably joined in such a way that said independent chamber(s) is/are sandwiched between tyre and master chamber.

3. The system as claimed in claim 1, wherein said multiple chambers in tube is manufactured by way of extrusion by providing multiple mandrels, separator is being provided between surfaces which are not intended to be joined, said multi-chambered tube is cut according to requirement of length, said master chamber is joined with a one way valve for air/fluid inlet, both ends of each individual chambers are joined by joiner in green state, said multi-chambered tube is being vulcanized as a single unit.

4. The system as claimed in claim 1, wherein said multiple chambers in tube is manufactured by way of extrusion of master chamber, joining of sheet material below or above said master chamber, separator is being provided between surfaces which are not intended to be joined, said multi-chambered tube is cut according to requirement of length, said master chamber is joined with a one way valve for air/fluid inlet, both ends of each individual chambers are joined by joiner in green state, said multi-chambered tubeless tyre is being vulcanized as a single unit.

5. The system as claimed in claim 1, wherein said multiple chambers in tubeless tyre is manufactured by joining surfaces of sheet(s) to inner surface of tubeless tyre in green state; wherein said sheet can be of shape of flat surface having at least one wall equidistant from both ends joining side walls of tubeless tyre.

6. The system as claimed in claim 1, wherein said multiple chambers is manufactured by joining green multiple chamber unit with green tubeless tyre or tube as the case may be, are being vulcanized in such manner that chambers nearer to the outer surface will be provided with heated vapour or non-reactive fluid by the valves of each chamber; said main chamber and inner circle of the tyre or tube are vulcanised by bellows or tubeless tyre or tube with only one additional chamber for sealant can be vulcanised with bellows or by heated vapour or both.

7. The system as claimed in claim 6, wherein said multiple chambers unit are made up of material having similar property of inner liner or butyl rubber by way of extrusion by providing multiple mandrels to make multiple chambers or extrusion of master chamber and joining of sheet material below or above said master chamber or extrusion/rolling of crescent shaped structure with elongated surfaces to act as inner liner; separator is being provided between surfaces which are not intended to be joined, said multiple chambered unit is cut according to requirement of length, said chambers are joined with a one way valve for air/fluid/sealant inlet, both ends of each individual chambers are being joined by joiner in a green state.

8. The system as claimed in claim 1, wherein said joiners, multiple chambers units or independent joiners are formed by way of rolling or extrusion in similar shaped die in such a shape and size so that they fit into requirement of edges.

9. The system as claimed in claim 1 wherein chambers cut of extruded part/sheet material is being cut perpendicular or V-shaped or angular such that cut surface is exposed to joiner or to outer surface, wherein two ends are joined by joiner by use of pressure and temperature or joining solution, said joiner is cylindrical shaped or crescent shaped with perpendicular or V-shaped or angular cut at its both ends and provided with one way valve on its surface.

10. The system as claimed in claim 1 wherein additional strip of material with similar property of said inner liner or said butyl rubber in such a way that it increases the strength of joining

11. The system as claimed in claim 1 wherein non reactive paint or sticky solution or layer is provided in inner surface of chamber wherein sealant is provided to increase life of sealant and tyre or tube.

12. The system as claimed in claim 1 wherein said sandwiched chamber is one chamber to have sealant, or multiple chamber with sealant or without sealant.

13. The system as claimed in claim 1 wherein said tyre is a self-supporting run flat tyre such that side wall thickness and/or strength and/or stiffness is in-between normal tubeless tire and self-supporting tubeless tyre.

14. The system as claimed in claim 1 wherein said tyre is auxiliary supported run flat tire.

15. The system as claimed in claim 1 wherein said tyre is extra wide tire with multiple chambers for commercial vehicles as a replacement of twin tire.

16. The system as claimed in claim 2, wherein said joiners, multiple chambers units or independent joiners are formed by way of rolling or extrusion in similar shaped die in such a shape and size so that they fit into requirement of edges.

17. The system as claimed in claim 2 wherein chambers cut of extruded part/sheet material is being cut perpendicular or V-shaped or angular such that cut surface is exposed to joiner or to outer surface, wherein two ends are joined by joiner by use of pressure and temperature or joining solution, said joiner is cylindrical shaped or crescent shaped with perpendicular or V-shaped or angular cut at its both ends and provided with one way valve on its surface.

18. The system as claimed in claim 2 wherein additional strip of material with similar property of said inner liner or said butyl rubber in such a way that it increases the strength of joining

19. The system as claimed in claim 2 wherein non reactive paint or sticky solution or layer is provided in inner surface of chamber wherein sealant is provided to increase life of sealant and tyre or tube.

20. The system as claimed in claim 2 wherein said tyre is extra wide tire with multiple chambers for commercial vehicles as a replacement of twin tire.
